(19) United States
(12) Patent Application Publication
(10) Pub. No.: US 2002/0032040 A1
(43) Pub. Date: Mar. 14, 2002

(54) Portable radio communication apparatus

(75) Inventor: Tadashi Tsukamoto, Tokyo (JP)

Correspondence Address: SUGHRUE, MION, ZINN, MACPEAK SEAS, PLLC, 2100 Pennsylvania Avenue, N.W., Washington, DC, 20037-3213, US

(73) Assignee: NEC CORPORATION

(21) Appl. No.: 09/949,833

(22) Filed: Sep. 12, 2001

(30) Foreign Application Priority Data
Sep. 14, 2000 (JP) 279917/2000

(51) Int. Cl. H04M 1/00

(52) U.S. Cl. 455/556; 455/567

(57) ABSTRACT

In a portable radio communication apparatus, a storage section stores an operation mode table, in which at least one operation mode that defines operation suitable for the operation environment of the apparatus is associated with settings for making sections operate in the operation mode, and a keyword table, in which a keyword representing the operation environment is associated with the operation mode. A schedule management section stores schedule management information indicating an action schedule of the user and manages the action schedule. An operation mode timetable generating section generates a timetable by extracting time at which the user starts acting, a flag being set at the time, and a keyword in the keyword table, the flag being added to the keyword, from the schedule management information. When the time at which the flag is set has come, an operation mode control section detects the operation mode corresponding to the keyword from the keyword table, detects settings corresponding to the operation mode from the operation mode setting table, and uses the settings.

### BACKGROUND OF THE INVENTION

1. Field of the Invention

The present invention relates to a portable radio communication apparatus such as a cellular phone set or portable information terminal equipment and, more particularly, to a portable radio communication apparatus having a schedule management function associated with user's actions.

2. Description of the Prior Art

With the widespread use of cellular phone sets, the voice of people has grown indicating problems about the manner of use in public places and the like. This indication is mainly associated with the generation of a ringing tone and the influences of electromagnetic waves generated by cellular phone sets. More specifically, a ringing tone of a cellular phone set in a public place such as a train or theater annoys others, or electromagnetic waves affect medical equipment in a hospital or crowded train.

For this reason, a current cellular phone set has operation modes capable of setting operations in various situations. For example, the cellular phone set has an operation mode generally called the “manner mode” in which the cellular phone set operates while minimizing the inconvenience to surrounding people.

According to an example of the manner mode, when this mode is set, the generation of a key click sound that is generated when a key is pressed is suppressed, and the generation of a ringing tone upon reception of an incoming call is suppressed. Instead of these sounds, vibrations of a vibrator are used to notify the user of an incoming call. In addition, the sensitivity of the microphone improves during speech communication to allow the user to communicate in a low voice.

Operation modes may be set in accordance with various situations by combining settings that indicate, for example, whether to turn on/off a key click sound, turn on/off a ringing tone, change a tone, turn on/off a vibrator upon reception of an incoming call, and turn on/turn off/blink an LED.

In consideration of the adverse effects of electromagnetic waves on medical equipment and the like in a hospital, crowded train, and the like, as well as ringing tones, settings that indicate, for example, whether to turn on/off the power supply and turn on/off the radio section power supply may be added as setting items for the operation mode.

A current cellular phone set can transmit/receive electronic mail and connect to the Internet as well as having the telephone function. That is, the cellular phone set tends to serve as a multimedia terminal staying in close touch with daily life. In addition, the cellular phone set is expected to be further equipped with functions as those of a portable information terminal equipment, e.g., the functions of managing an address book, storing memos, and managing a schedule, and hence is evolving into a most familiar personal portable information terminal equipment.

In a conventional cellular phone set, the user switches operation modes associated with the settings that indicate, for example, whether to turn on/off a ringing tone upon reception of an incoming call and turn on/off a vibrator. If, however, the user forgets to perform switching operation, a ringing tone may be generated in a public place or radio waves may affect the surroundings.

### SUMMARY OF THE INVENTION

The present invention has been made to solve the above problems in the conventional portable radio communication apparatus, and has as its object to provide a portable radio communication apparatus such as a cellular phone set which can reliably switch operation modes.

In order to achieve the above object, according to the first aspect of the present invention, there is provided a portable radio communication apparatus having a schedule management function of storing and managing an action schedule of a user, comprising a storage section storing an operation mode table, in which at least one operation mode that defines operation suitable for an operation environment of the portable radio communication apparatus is associated with settings for making sections operate in the operation mode, and a keyword table, in which a keyword representing the operation environment is associated with the operation mode, a schedule management section for storing schedule management information indicating an action schedule of the user and managing the action schedule of the user, an operation mode timetable generating section for generating a timetable by extracting time at which the user starts acting, a flag being set at the time, and a keyword in the keyword table, the flag being added to the keyword, from the schedule management information, and an operation mode control section for, when the time at which the flag is set has come, detecting the operation mode corresponding to the keyword added to the flag from the keyword table, detecting settings for the respective sections corresponding to the operation mode from the operation mode setting table, and using the settings.

According to the portable radio communication apparatus of the first aspect, a timetable to which a flag indicting the time at which operation modes are switched is added is automatically generated in advance by the operation mode timetable generating section on the basis of the schedule management information generated by the schedule management section. At the predetermined time, therefore, the operation mode of the portable radio communication apparatus is automatically switched to the operation mode corresponding to the timetable automatically generated by the operation mode control section.

In order to achieve the above object, according to the second aspect of the present invention, there is provided a portable radio communication apparatus having a schedule management function of storing and managing an action schedule of a user, comprising a storage section storing an operation mode table, in which at least one operation mode that defines operation suitable for an operation environment of the portable radio communication apparatus is associated with settings for making sections operate in the operation mode, a schedule management section for storing schedule management information indicating an action schedule of the user and managing the action schedule of the user, an operation mode management section for generating a timetable, in which an operation mode used at predetermined time is set in advance, on the basis of the schedule management information, and an operation mode control section for, when the time at which operation modes are switched in the timetable has come, detecting settings for sections which correspond to a new operation mode from an operation mode setting table, and using the settings.

According to the portable radio communication apparatus of the second aspect, a timetable for switching operation modes is automatically generated by the operation mode management section on the basis of the schedule management information generated by the schedule management section. At the predetermined time, therefore, the operation mode of the portable radio communication apparatus is automatically switched to the operation mode corresponding to the timetable automatically generated by the operation mode control section.

The operation mode in either of the first and second aspects defines at least one of communication control settings including settings that indicate whether to generate a ringing tone upon reception of an incoming call, activate a vibrator upon reception of an incoming call, and turn on or blink an LED upon reception of an incoming call.

The operation mode in either of the first and second aspects defines at least one of apparatus control settings including settings that indicate whether to generate a key click sound upon key operation, turn on an apparatus power supply, and turn on a radio section power supply.

The portable radio communication apparatus in either of the first and second aspects comprises a cellular phone set.

The portable radio communication apparatus in either of the first and second aspects comprises a portable information terminal equipment.

As is obvious from the respective aspects, according to the present invention, since operation modes are automatically switched, the portable radio communication apparatus can always be used according to the settings for an operation mode suitable for the operation environment. For example, this makes it possible to prevent the user from forgetting to turn off the power in a concert or turn off a ringing tone during a meeting. This therefore allows the user to behave properly and prevents him/her from annoying others.

The above and many other objects, features and advantages of the present invention will become manifest to those skilled in the art upon making reference to the following detailed description and accompanying drawings in which preferred embodiments incorporating the principle of the invention are shown by way of illustrative examples.

### BRIEF DESCRIPTION OF THE DRAWINGS

FIG. 1 is a block diagram showing the main constituent elements of a cellular phone set according to the first embodiment of the present invention;

FIG. 2 is a view showing an example of an operation mode setting table in the first embodiment;

FIG. 3 is a view showing an example of a keyword table in the first embodiment;

FIG. 4 is a view for explaining the operation of an operation mode timetable generating section in the first embodiment;

FIG. 5 is a flow chart showing the operation of an operation mode control section in the first embodiment;

FIG. 6 is a block diagram showing the main constituent elements of a cellular phone set according to the second embodiment of the present invention;

FIG. 7 is a view for explaining the operation of an operation mode management section in the second embodiment; and

FIG. 8 is a flow chart showing the operation of an operation mode control section in the second embodiment.

### DETAILED DESCRIPTION OF THE PREFERRED EMBODIMENTS

Several preferred embodiments of the present invention will be described below with reference to the accompanying drawings. Although each embodiment will exemplify the cellular phone set, the present invention is not limited to this.

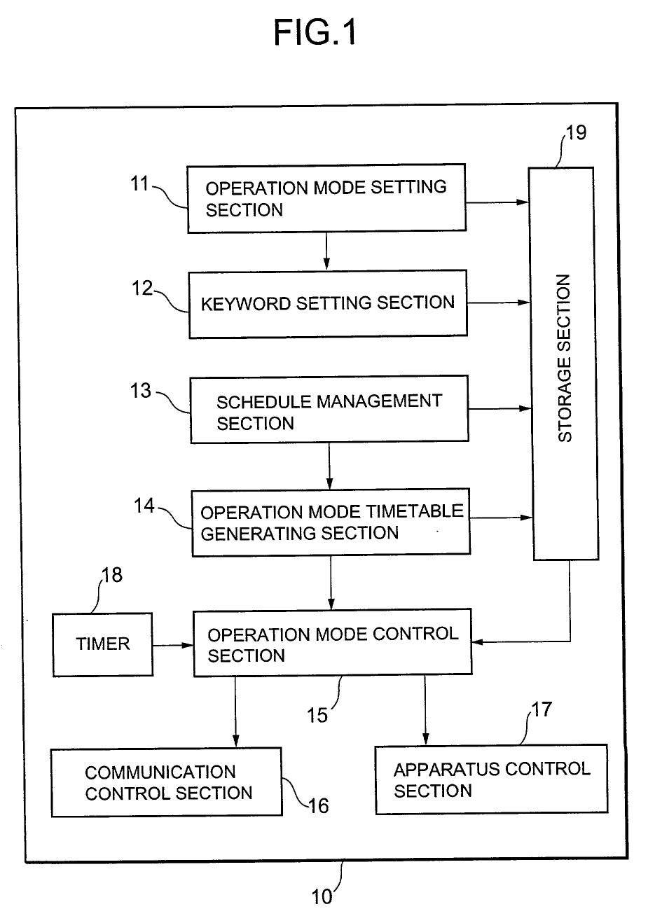

FIG. 1 is a block diagram showing the main constituent elements of a cellular phone set 10 according to the first embodiment of the present invention.

Referring to FIG. 1, the cellular phone set 10 has an operation mode setting section 11, keyword setting section 12, schedule management section 13, operation mode timetable generating section 14, operation mode control section 15, communication control section 16, apparatus control section 17, timer 18, and storage section 19.

The operation mode setting section 11 sets at least one operation mode suitable for a predetermined operation state in accordance with a user request and stores it as an operation mode setting table in the storage section 19. For example, in such an operation mode, the following settings are set: whether to generate a ringing tone or vibration upon reception of an incoming call, whether to activate/inactivate (turn on/off) a termination LED, whether to generate a key click sound, whether to energize a radio section power supply, and the like. On the operation mode table, at least one operation mode and corresponding settings are recorded.

The keyword setting section 12 sets a keyword representing an operation state corresponding to the operation mode set by the operation mode setting section 11 in accordance with a user's request and records it as a keyword table in the storage section 19.

The schedule management section 13 records a user's action schedule corresponding to a date as schedule management information in the storage section 19.

The operation mode timetable generating section 14 automatically generates a timetable for switching operation modes on the basis of the schedule management information and records it in the storage section 19.

In the timetable, flags are set in correspondence with the start and end times of the respective actions. If the keyword set by the keyword setting section 12 is included in information indicating a scheduled action that starts at given time, the keyword is added to the corresponding flag. If no keyword is included in information representing the scheduled action that starts at that time, no keyword is added to the flag. If there is no scheduled action that starts at the time, “normal” is added as a keyword to the flag.

The operation mode control section 15 performs time management in accordance with the time indicated by the timer 18. When the time corresponding to a given flag in the timetable has come, the operation mode control section 15 detects an operation mode corresponding to the keyword added to the flag from the keyword table, and detects the respective settings corresponding to the operation mode from the operation mode setting table. The operation mode control section 15 then gives the communication control section 16 and apparatus control section 17 instructions for the respective settings. Note that if “normal” is detected as a keyword, each setting is restored to a normal state.

The communication control section 16 controls originating/terminating operations of a phone or the like in accordance with the instructions for the respective settings given by the operation mode control section 15, e.g., instructions for settings about whether to generate a ringing tone or vibration upon reception of an incoming call, turn on/off the termination LED.

The apparatus control section 17 controls turning on/off of a key click sound, energization of the apparatus power supply or radio section power supply, and the like in accordance with instructions from the operation mode control section 15.

The timer 18 manages time and a time interval in the cellular phone set 10.

The storage section 19 stores the data generated by other sections.

An example of the operation of the cellular phone set 10 according to the first embodiment of the present invention will be described next.

Settings for the operation modes desired by the user have already been recorded as an operation mode setting table in the storage section 19 by the operation mode setting section 11.

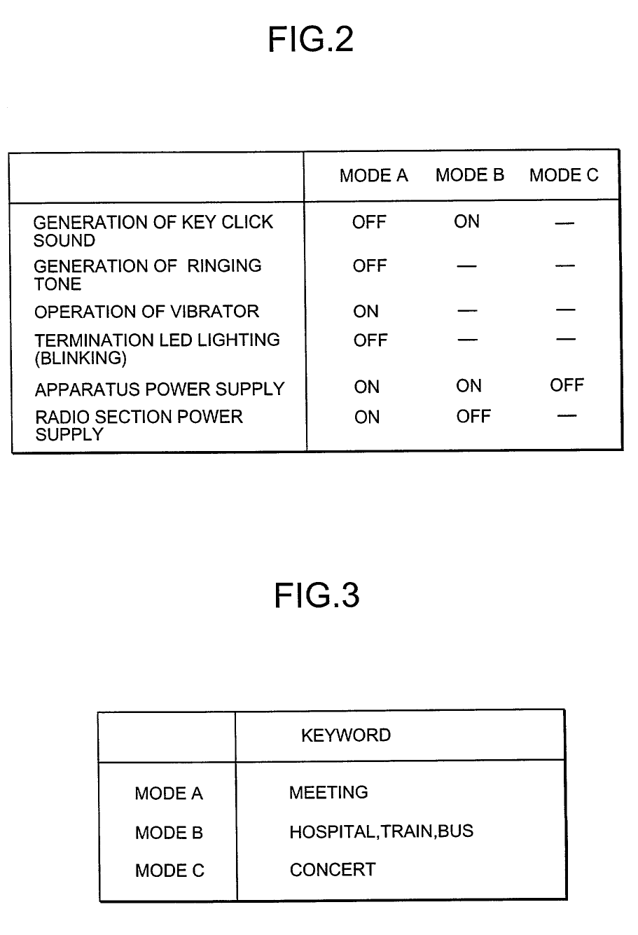

FIG. 2 shows an example of the settings for the operation modes. Referring to FIG. 2, three operation modes, namely modes A, B, and C, are set in the first embodiment. In the mode A, “key click sound” is OFF, “generation of ringing sound” is OFF, “termination vibration (vibrator)” is ON, “termination LED lighting” is OFF, “apparatus power supply” is ON, and “radio section power supply” is ON. In the mode B, “key click sound” is ON, “apparatus power supply” is ON, “radio section power supply” is OFF, and “radio section power supply” is OFF. In this mode, since “radio section power supply” is OFF, there is no need to make settings for the vibrator and termination LED. In the mode C, “apparatus power supply” is OFF, and hence there is no need to make settings for “key click sound”, “generation of ringing tone”, “vibrator”, “termination LED lighting”, and “radio section power supply”.

Keywords representing operation states corresponding to the respective operation modes have been set by the keyword setting section 12 in accordance with user's requests and recorded as a keyword table in the storage section 19. One or a plurality of keywords may be set for each operation mode.

FIG. 3 shows an example of the keyword table. Referring to FIG. 3, “meeting” is set as a keyword corresponding to the mode A; “hospital”, “train”, and “bus” as keywords corresponding to the mode B; and “concert” as a keyword corresponding to the mode C.

A user action schedule has already been recorded as schedule management information in the storage section 19 by the schedule management section 13.

First of all, the cellular phone set 10 generates a timetable from the schedule management information by using the operation mode timetable generating section 14 and records it in the storage section 19.

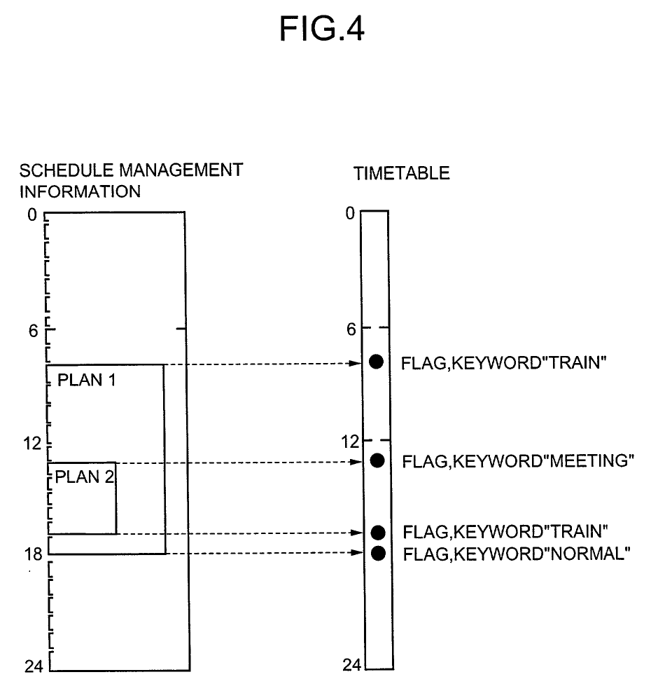

FIG. 4 shows an example of the correspondence between the schedule management information and the timetable. Referring to FIG. 4, plans 1 and 2 are set in the schedule management information.

According to the schedule of this day, the user leaves home at 8:00, moves to his/her destination by train, holds a meeting at the destination from 13:00 to 17:00, and moves by train, from 17:00 to 18:00, to the hotel where he/she stays. In plan 1, information indicating that the user is on a business trip from 8:00 to 18:00 and moves by “train” from home to the destination and from destination to the place where he/she stays is recorded. In plan 2, information indicating that the user holds a “meeting” at the destination from 13:00 to 17:00 is recorded.

The keyword “train” for which a flag is set at 8:00 is added to the generated timetable. Likewise, the keyword “meeting” for which a flag is set at 13:00 and the keyword “train” for which a flag is set at 17:00 are added to the timetable. No keyword for which a flag is set at 18:00 is added.

The telephone exchange 1 then gives the communication control section 16 and apparatus control section 17 instructions for the respective settings.

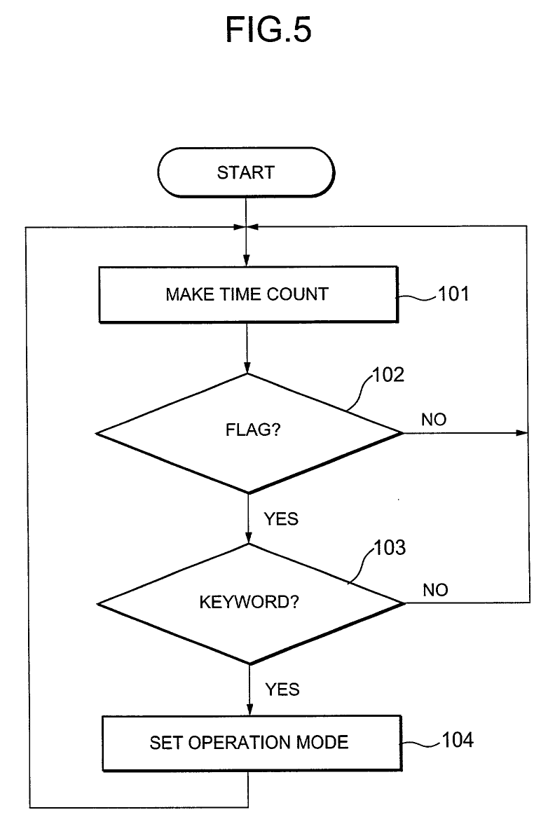

FIG. 5 is a flow chart showing the operation of the operation mode control section 15. Referring to FIG. 5, the operation mode control section 15 makes time count by using the timer 18 in step 101, and checks in step 102 whether a flag is set at the corresponding time in the timetable.

If no flag is set, the flow returns to step 101 to continue time count. If a flag is set, the operation mode control section 15 checks in step 103 whether a keyword is added to the flag.

If no keyword is added, the flow returns to step 101 to continue time count. If a keyword is added, the operation mode control section 15 detects an operation mode corresponding to the keyword from the keyword table, and detects the respective settings for the operation mode from the operation setting table. The operation mode control section 15 then gives the communication control section 16 and apparatus control section 17 corresponding instructions.

The cellular phone set 10 controls operation by using the communication control section 16 and apparatus control section 17 in accordance with instructions from the operation mode control section 15.

For example, since the keyword “train” is added to the flag corresponding to 8:00, the cellular phone set 10 automatically operates at 8:00 according to the settings indicating that “generation of key click sound” is OFF, “generation of ringing sound” is OFF, “vibrator” is ON, “termination LED lighting” is OFF, “apparatus power supply” is ON, and “radio section power supply” is ON.

Although the first embodiment of the present invention has exemplified the cellular phone set, the present invention can be applied to a portable information terminal equipment having a radio communication function. In this case, the arrangement of each section of the portable information terminal equipment which is a characteristic feature of the present invention is the same as that of the cellular phone set 10 in FIG. 1.

The operation mode timetable generating section 14 automatically generates a timetable to which flags indicating the times at which operation modes are switched are added from the schedule management information generated by the schedule management section 13. The operation mode control section 15 then automatically switches the operation modes in accordance with the timetable. This allows the communication control section 16 and apparatus control section 17 to always operate according to operation modes suitable for operation states. For example, this prevents the user from forgetting to turn off the power during a concert or turn off a ringing sound during a meeting. This therefore allows the user to behave properly and prevents him/her from annoying others.

A cellular phone set 20 according to the second embodiment of the present invention will be described next.

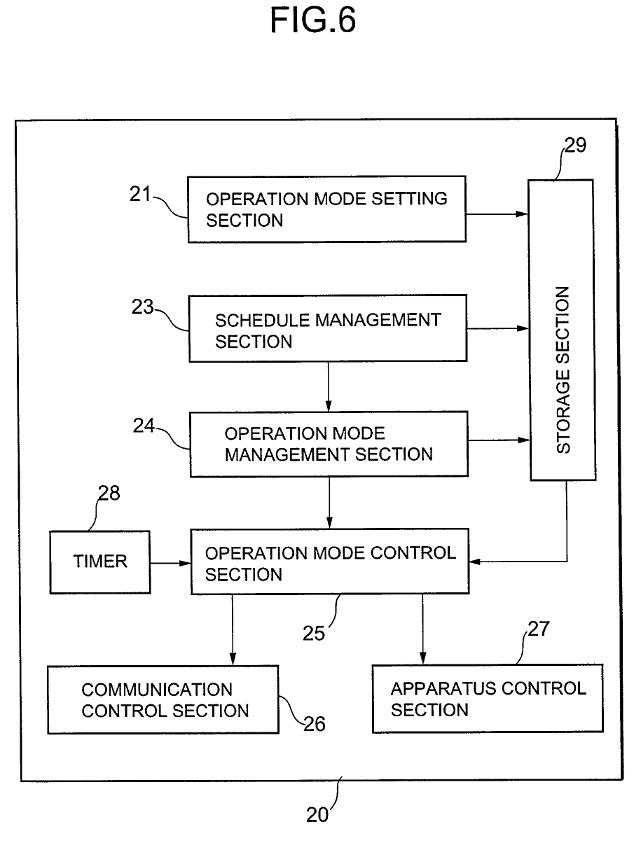

Referring to FIG. 6, the cellular phone set 20 includes an operation mode setting section 21, schedule management section 23, operation mode management section 24, operation mode control section 25, communication control section 26, apparatus control section 27, timer 28, and storage section 29.

The operation mode setting section 21, schedule management section 23, communication control section 26, apparatus control section 27, timer 28, and storage section 29 are identical to the operation mode setting section 11, keyword setting section 12, schedule management section 13, communication control section 16, apparatus control section 17, timer 18, and storage section 19 in FIG. 1.

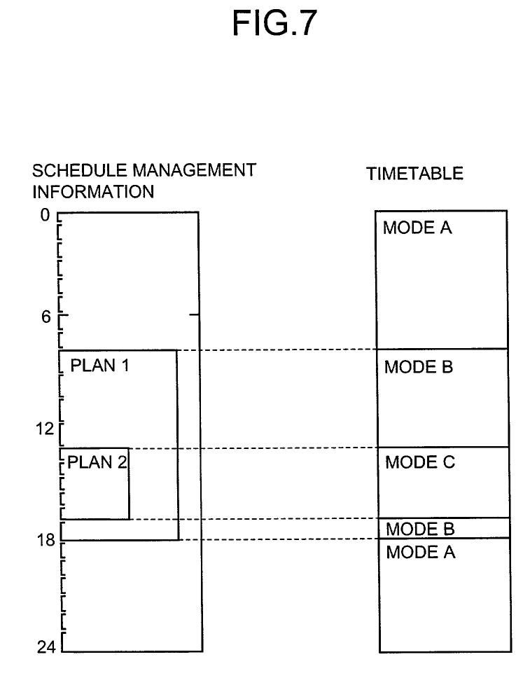

As shown in FIG. 7, the operation mode management section 24 generates a timetable in which operation modes used at the respective times are set on the basis of schedule management information and records it on the storage section 29. According to an example of the method of generating a timetable, information indicating operation modes are set in advance in schedule management information in accordance with user's requests, and operation modes are extracted from the information to be recorded on a timetable. As in the portable radio communication apparatus (cellular phone set) 10 in FIG. 1, the correspondence between operation modes and keywords may be set in advance, a keyword may be extracted from the schedule management information, and an operation mode corresponding to the keyword may be recorded on a timetable.

The operation mode control section 25 performs time management in accordance with the time indicated by the timer 28, and determines an operation mode on the basis of the timetable generated by the operation mode management section 24. The operation mode control section 25 then detects the respective settings for the operation mode from the operation mode setting table and gives the communication control section 26 and apparatus control section 27 instructions for the respective settings.

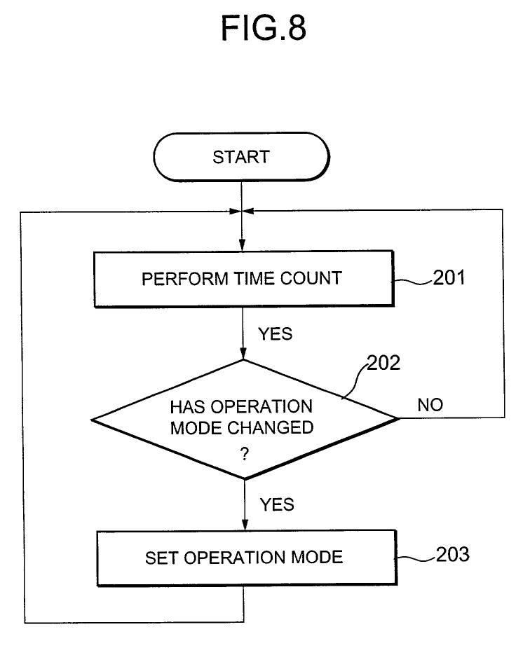

Referring to FIG. 8, the operation mode control section 25 operates as follows. First of all, in step 201, the operation mode control section 25 performs time count by using the timer 28, and checks on the timetable in step 202 at the corresponding time whether the operation mode has changed. If the operation mode has not changed, the flow returns to step 201 to continue time count. If the operation mode has changed, the flow advances to step 203 to detect the respective settings for the new operation mode from the operation mode table. The operation mode control section 25 then gives the communication control section 26 and apparatus control section 27 corresponding instructions.

The operation mode management section 24 automatically generates a timetable for switching operation modes from the schedule management information generated by the schedule management section 23. The operation mode control section 25 automatically switches the operation modes in accordance with the timetable. As in the cellular phone set 10 in FIG. 1, the communication control section 26 and apparatus control section 27 can always operate in an operation mode suitable for each situation.

What is claimed is:

1. A portable radio communication apparatus having a schedule management function of storing and managing an action schedule of a user, comprising:
(a) a storage section storing an operation mode table, in which at least one operation mode that defines operation suitable for an operation environment of said portable radio communication apparatus is associated with settings for making sections operate in the operation mode, and a keyword table, in which a keyword representing the operation environment is associated with the operation mode;
(b) a schedule management section for storing schedule management information indicating an action schedule of the user and managing the action schedule of the user;
(c) an operation mode timetable generating section for generating a timetable by extracting time at which the user starts acting, a flag being set at the time, and a keyword in the keyword table, the flag being added to the keyword, from the schedule management information; and
(d) an operation mode control section for, when the time at which the flag is set has come, detecting the operation mode corresponding to the keyword added to the flag from the keyword table, detecting settings for the respective sections corresponding to the operation mode from the operation mode setting table, and using the settings.

2. An apparatus according to claim 1, wherein the operation mode defines at least one of communication control settings including settings that indicate whether to generate a ringing tone upon reception of an incoming call, activate a vibrator upon reception of an incoming call, and turn on or blink an LED upon reception of an incoming call.

3. An apparatus according to claim 1, wherein the operation mode defines at least one of apparatus control settings including settings that indicate whether to generate a key click sound upon key operation, turn on an apparatus power supply, and turn on a radio section power supply.

4. An apparatus according to claim 1, wherein said portable radio communication apparatus comprises a cellular phone set.

5. An apparatus according to claim 1, wherein said portable radio communication apparatus comprises a portable information terminal equipment.

6. A portable radio communication apparatus having a schedule management function of storing and managing an action schedule of a user, comprising:
(a) a storage section storing an operation mode table, in which at least one operation mode that defines operation suitable for an operation environment of said portable radio communication apparatus is associated with settings for making sections operate in the operation mode;
(b) a schedule management section for storing schedule management information indicating an action schedule of the user and managing the action schedule of the user;
(c) an operation mode management section for generating a timetable, in which an operation mode used at predetermined time is set in advance, on the basis of the schedule management information; and
(d) an operation mode control section for, when the time at which operation modes are switched in the timetable has come, detecting settings for sections which correspond to a new operation mode from an operation mode setting table, and using the settings.

7. An apparatus according to claim 6, wherein the operation mode defines at least one of communication control settings including settings that indicate whether to generate a ringing tone upon reception of an incoming call, activate a vibrator upon reception of an incoming call, and turn on or blink an LED upon reception of an incoming call.

8. An apparatus according to claim 6, wherein the operation mode defines at least one of apparatus control settings including settings that indicate whether to generate a key click sound upon key operation, turn on an apparatus power supply, and turn on a radio section power supply.

9. An apparatus according to claim 6, wherein said portable radio communication apparatus comprises a cellular phone set.

10. An apparatus according to claim 6, wherein said portable radio communication apparatus comprises a portable information terminal equipment.
